(19) United States
(12) Patent Application Publication
(10) Pub. No.: US 2008/0123755 A1
(43) Pub. Date: May 29, 2008

(54) Method and apparatus for data transmission

(76) Inventor: Axel Clausen, Muenchen (DE)

Correspondence Address: INFINEON TECHNOLOGIES AG;Patent Department, MUC 11.1.507, P.O. Box 221644, Munich, 80506, omitted

(21) Appl. No.: 11/522,801

(22) Filed: Sep. 18, 2006

(51) Int. Cl. H04L 27/28

(52) U.S. Cl. 375/260

(57) ABSTRACT

A first device provides a first signal transmitted to a second device. The second device generates information related to precompensation based on the first signal.

### REFERENCE TO RELATED APPLICATIONS

This application is related to an application having assignees Ref.No. 2006P52821US, filed Sep. 18, 2006, the contents of which are herein incorporated by reference in their entirety.

### FIELD OF THE INVENTION

The invention relates generally to data transmission apparatus and methods.

### BRIEF DESCRIPTION OF THE DRAWINGS

The accompanying drawings are included to provide a further understanding of the present invention and are incorporated in and constitute a part of this specification. The drawings illustrate the embodiments of the present invention and together with the description serve to explain the principles of the invention. Other embodiments of the present invention and many of the intended advantages of the present invention will be readily appreciated as they become better understood by reference to the following detailed description. The elements of the drawings are not necessarily to scale relative to each other. Like reference numerals designate corresponding similar parts.

FIGS. 1a, 1b and 1c are diagrams illustrating embodiments of the invention.

FIG. 2 is a block diagram illustrating embodiments of a transmission system.

FIG. 3 is a flow diagram illustrating one embodiment of the invention.

FIG. 4 is a block diagram illustrating one embodiment of the invention.

FIG. 5 is a block diagram illustrating an embodiment of the invention.

FIG. 6 is a flow diagram illustrating an embodiment of the invention.

FIGS. 7a and 7b are diagrams illustrating embodiments of the invention.

FIGS. 8a and 8b are block diagrams illustrating embodiments of the invention.

### DETAILED DESCRIPTION

The following detailed description explains exemplary embodiments of the invention. The description is not to be taken in a limiting sense, and is made for the purpose of illustrating the general principles of embodiments of the invention. The scope of the invention, however, is defined by the claims and is not intended to be limited by the embodiments described herein.

The term “Data” as used to describe one or more embodiments of the invention is not limited to any specific data and may include for example voice data, multimedia data, text data, graphic data or other computer data.

The term “carrier” as used to describe one or more embodiments of the invention includes a tone or frequency sub-range of an equally or non-equally divided frequency range used for transmission of information on a transmission line. The term “carrier” might also be known in the art as sub carrier.

Modulation of information onto a carrier as used to describe one or more embodiments of the invention includes any assignment of information to this carrier to generate a signal comprising the information in any form within the signal. Modulation may for example comprise assignment to symbols, representatives of symbols or constellations. The assignment may use bitloadings and constellation vectors within a complex frequency domain. Modulation may according to embodiments of the present invention include QAM (Quadrature Amplitude Modulation), OFDM modulation (Orthogonal Frequency Division Multiplexing), DMT (Discrete Multi-tone) modulation, but is not limited thereto. 16 QAM (16 Quadrature Amplitude Modulation), QPSK (Quadrature Phase Shift Keying), DQPSK (Differential Quadrature Phase Shift Keying), BPSK (Binary Phase Shift Keying) or higher modulation schemes may be used for modulation.

“Transmission line” as used to describe one or more embodiments of the invention may be interpreted broadly and includes every physical transmission medium such as electrical lines, for example twisted pair lines, copper lines, coaxial lines or other physical lines.

“Band” as used to describe one or more embodiments of the invention includes a plurality of carrier grouped together which may be dependent on the specific standard used for transmission. The number of bands and whether they are used for transmission in both directions or in one direction (such as upstream and/or downstream) may depend on the specific standard used, for example VDSL, VDSL2, ADSL, ADSL+.

The term “xDSL” as used to describe one or more embodiments of the invention may be a synonym for all DSL-based techniques including but not limited to HDSL, HDSL2, ADSL, ADSL2, ADSL2+, VDSL, VDSL2, SDSL, IDSL, G.SHDL.

The term “symbol in the frequency domain” as used to describe one or more embodiments of the invention may refer to a vector or representative of a vector in the frequency domain corresponding to constellation points assigned to each of the carriers of a transmission system.

The term DMT-symbol or OFDM-symbol as used to describe one or more embodiments of the invention may refer to a signal in time domain generated after a frequency-to-time conversion of the symbol in the frequency domain which may comprise extensions such as a cyclic prefix or a cyclic suffix. The term DMT-symbol or OFDM-symbol as used to describe one or more embodiments of the invention may be sometimes referred to in the art as DMT-frame or OFDM-frame.

In the illustrated embodiments, transmission systems can include a first device or apparatus having a transmitter that transmits signals representing information along a transmission line that couples the first device and a second device to a receiver of the second device. In many transmission systems, the first device may not only be coupled to the second device but also to one or more other devices. In some embodiments, a plurality of transmission lines are coupled to the first device and the transmission lines may be in close proximity or in contact with each other, such as with a bundle of transmission lines. As a result, crosstalk of signals transmitted on one of the transmission lines to other transmission lines can effect transmission on one or more of the plurality of transmission lines.

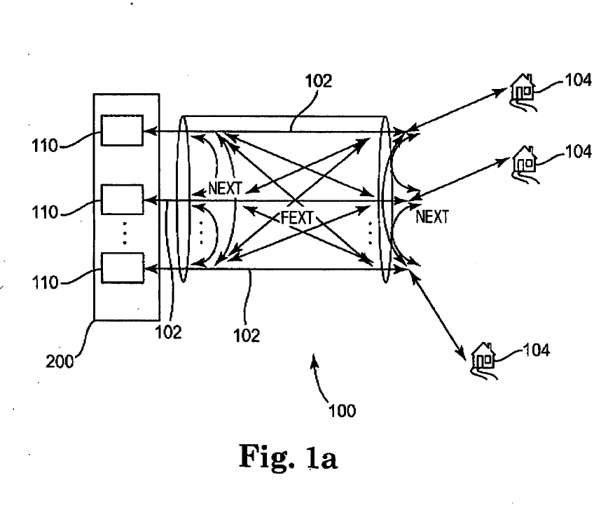

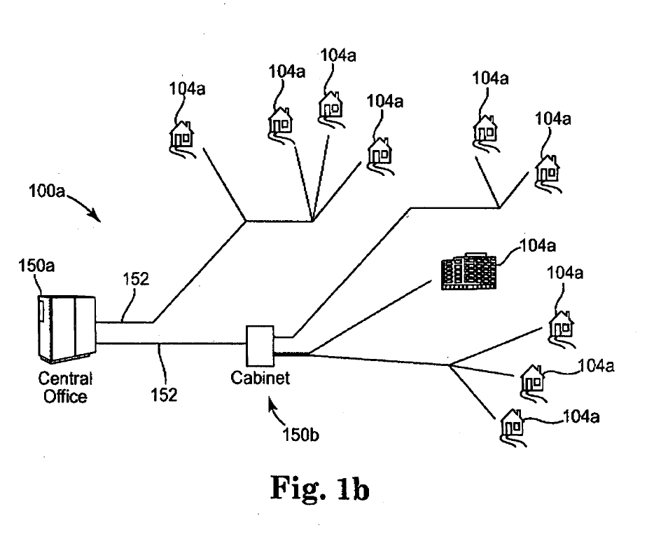

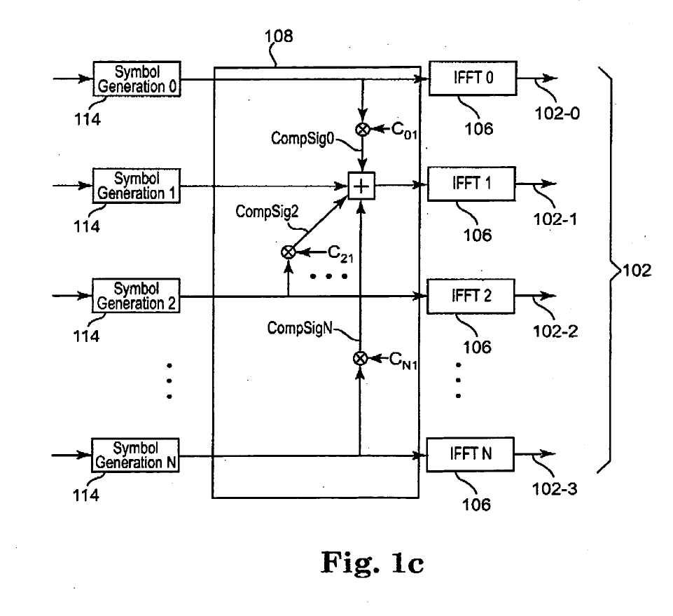

FIG. 1a is a diagram illustrating one embodiment of cross coupling in a transmission system 100 that includes a plurality of transmission lines 102. The transmission system 100 comprises a first apparatus 200 having a plurality of N transceivers 110, wherein each transceiver 110 transmits and receives signals over one or more of the transmission lines 102, to the plurality of transceivers 104. The transceivers 104 may include in embodiments Customer Premises Equipment (CPE) such as a modem or router located for example at the home or office of subscribers of the transmission system 100. The apparatus 200 may be any transceiving unit. In one embodiment, the apparatus 200 is a Central Office (CO) such as the central office 150a, or is a cabinet 150b as shown in FIG. 1b.

FIG. 1b is a diagram of a transmission system 100a illustrating one embodiment of telephone lines. In the illustrated embodiment, the telephone lines comprise twisted pairs of copper lines that are used to transmit signals that can include xDSL or other suitable signals from the central office 150a to a plurality of modems 104a. The telephone lines connected to the central office are arranged at least over some distance in cable bundles 152 which may be connected to a cabinet 150b or directly connected to the modems 104a by splitting up the telephone lines of each cable bundle 152. Telephone lines connected between the cabinet 150b and the modems 104a may, in some embodiments, be aggregated in cable bundles which may be smaller than the cable bundles connected to central office 150a.

Referring to FIG. 1a, the cross-coupling appearing between the transmission lines 102 may be divided into near end cross-coupling or “Near End Cross(X) Talk” (NEXT) and far end cross-coupling or “Far End Cross(X) Talk” (FEXT). In this embodiment, NEXT is the noise affecting a receiver that is located at a same end of a cable as a transmitter that is the noise source, and FEXT is the noise affecting a receiver that is located at a different end of a cable as a transmitter that is the noise source. In one embodiment, signals transmitted in a same direction can exhibit FEXT.

In the illustrated embodiments, if a direct communication channel between receivers exist (e.g. the receiver devices are coordinated), crosstalk related to FEXT may be addressed by compensation at the receiver side. In embodiments of systems where no communication channel between the receiving devices exists, compensation of FEXT at the receiver side is difficult if information regarding the data transmitted on the other transmission lines is not available at the receiver side.

In one embodiment, in order to allow compensation of crosstalk related to FEXT, a technique known as precompensation (sometimes referred in the art also as preceding or precancellation) may be used at the transmitter side. With precompensation the effect of crosstalk experienced by a signal during transmission is computed or estimated prior to transmitting the signal and the signal is modified based on this information. In various embodiments, this can be performed by subtracting the calculated crosstalk from the transmission signal or by adding the inverse of the calculated crosstalk. During transmission when the transmission signal is exposed to the crosstalk, the transmission signal and the crosstalk are summed thereby resulting in the original or nearly original, i.e. unmodified or nearly unmodified signal, as provided at the transmitting side. In some embodiments, other noise may be added during transmission.

In the illustrated embodiments, computation of the crosstalk utilizes information related to signals transmitted on other transmission lines concurrently. In some embodiments, this information is available at the transmitter side as one or more devices may transmit on the transmission lines. The information related to signals on the transmission line may be derived from the data transmitted on the transmission line. In one embodiment, this is achieved by transferring information to a central controlling machine of the transmitting device.

In some embodiments, information related to the cross coupling of transmission lines, for example, to the percentage of power that is coupled from a first transmission line to a second transmission line, may be provided with the precompensation technique. In various embodiments, the information may include crosstalk channel estimates or other information including crosstalk coupling coefficients.

FIG. 1c illustrates a schematic view of one embodiment of precompensation at a transmitter side. As shown in FIG. 1c, for each of the plurality of transmission lines 102, a symbol generator 114 is provided for generating a symbol in the frequency domain according to information received at an input of each symbol generator 114. In one embodiment, a vector DSL-transmission may be provided wherein the signals of a plurality of DSL-transmission lines are coded and decoded simultaneously.

In various embodiments, a symbol in the frequency domain may be interpreted as a vector of constellation points for each of the carriers in the frequency domain spanned by real and imaginary axes corresponding to cosine-and sine functions. In other embodiments, other symbols for line coding may be provided by symbol generators 114 depending on the line coding used for transmission system 100. In the illustrated embodiment, each of the symbol generators 114 are coupled to frequency-to-time converters 106. In one embodiment, the frequency-to-time converters 106 are IFFT units (IFFT=Inverse Fast Fourier Transformation) that convert the symbols which represent a signal in a frequency space into signals in time space which are transmitted over transmission lines 102 to the receiver side. In the illustrated embodiment, between the plurality of symbol generators 114 and the plurality of frequency-to-time-converters 106, a precompensator 108 is provided to modify the symbols prior to converting same at the frequency-to-time converters 106. The precompensator 108 shown in FIG. 1c provides a linear precompensation by using an N'3N matrix providing precompensation values C_{k,l}. The precompensation values C_{k,l} may be used to provide a plurality of compensation signals CompSig combined, (i.e. in various embodiments added, subtracted or otherwise combined with the symbols generated by symbol generators 114). In one embodiment, to provide precompensation for the second transmission line 102-1 of the plurality of N+1 transmission lines 102, the N signals representing the symbols generated by symbol generators 114 other than the symbol generator corresponding to the transmission line 102-1 are each multiplied by a coefficient C_{k,l} to generate compensation signals CompSig0, compSig2, . . . CompSigN, which are added to the signal representing the symbol generated by the symbol generator 114 coupled to transmission line 102-1.

While the embodiment shown in FIG. 1c provides precompensation by modifying symbols in the frequency domain, in other embodiments, symbols may be modified in the time domain for precompensation.

The compensation information used in embodiments of the precompensator 108, such as the compensation coefficients of the system illustrated in FIG. 1c, may be obtained in embodiments during a training sequence of the system, for example during initialization of one of the modems connected to the apparatus 200. The precompensation information may furthermore be modified in embodiments during a normal operation of the system in order to allow adapting to changes of the system or system environment.

According to embodiments of the invention, a signal is generated by a first apparatus or device, for example the CO or the cabinet illustrated in FIG. 1b, and transmitted to a second apparatus, for example a modem as illustrated in FIG. 1b. Information related to the cross coupling experienced during the transmission of the signal is generated at the second apparatus and feed-back to the first apparatus in order to allow the modification of the coefficients, for example during training or normal operation adjustment.

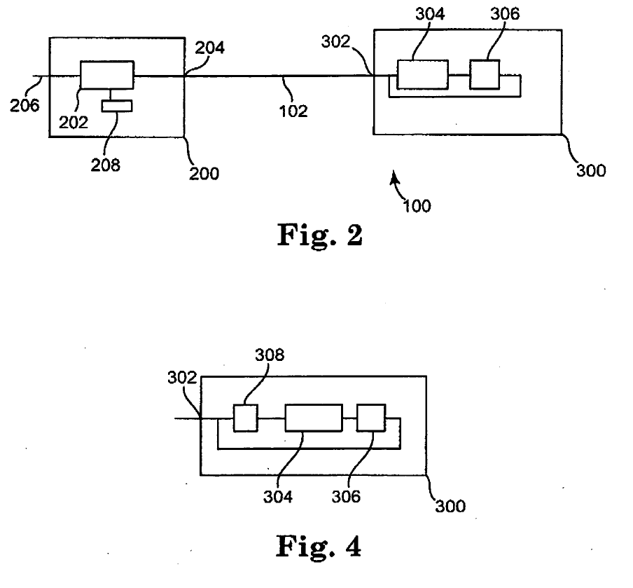

FIG. 2 illustrates a block diagram of a transmission system 100 comprising a first apparatus 200, a second apparatus 300 and transmission line 102 coupling the first and second apparatus. According to one embodiment illustrated in FIG. 2, the signals generated by a first device may be based on predetermined information. The apparatus 200 illustrated in FIG. 2 comprises a modulator 202 that is configured to modulate information received at an input 206 of the apparatus 200 onto a first plurality of carriers provided for transmission from apparatus 200 to apparatus 300 to generate a transmission signal. The modulator 202 is coupled to a terminal 204 configured to transmit the transmission signals generated by modulator 202 over transmission line 102. A controller 208 is coupled to the modulator 202 and controls the modulator. In one embodiment, controller 208 controls the modulator 202 such that a first transmission signal of the plurality of transmission signals is based on predetermined information. According to one embodiment, the predetermined information is stored within the apparatus 200 such that the first transmission signal is not based on information received at the input 206. According to one embodiment, the first transmission signal is not based on useful data, i.e. data which is requested by a user or may be used by a user's end device such as a computer of a user.

In the illustrated embodiment, apparatus 300 comprises a terminal 302 configured to receive the first transmission signal, and comprises a machine 304 configured to generate information related to crosstalk on the transmission line during the transmission of the first transmission signal. In some embodiments, machine 304 generates the information related to crosstalk based on a comparison of second information related to the received first transmission signal with information based on the predetermined information. In the illustrated embodiment, apparatus 300 further comprises a modulator 306 coupled to the terminal 302 that generates and transmits a transmission signal. In one embodiment, this transmission signal represents the information related to crosstalk from the second device to the first device. In various embodiments, apparatus 300 may comprise a memory that stores full predetermined information, or may comprise a machine that generates the predetermined information based on reduced predetermined information which may be stored in a memory. In some embodiments, apparatus 300 comprises a feedback register or machine that simulates a feedback register generating information based on the stored reduced predetermined information.

In various embodiments, the transmission system 100 may be a xDSL system such as a VDSL, VDSL2, ADSL, ADSL2 or ADSL2+ system. In some embodiments, the carriers provided for transmission system 100 may be divided such that a first band or a first plurality of bands of the transmission system are used for transmission in one direction, for example from apparatus 200 to apparatus 300, and a second band or a plurality of second bands that are used for transmission in the opposite direction. According to one embodiment, apparatus 200 may be a CO or a cabinet, as shown in FIG. 1b. In other embodiments, apparatus 300 may be a modem such as one or more of the modems shown in FIG. 1b, or may be a router or other CPE.

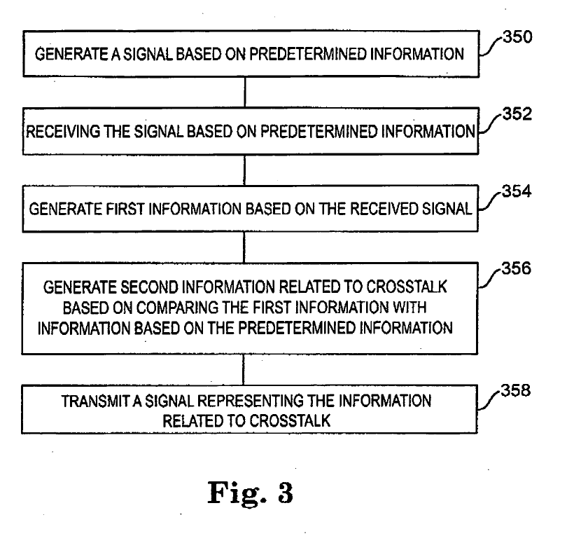

FIG. 3 illustrates a flow diagram of one embodiment of the operation of a system illustrated in FIG. 2. At step 350, the signal is generated based on predetermined information. At step 352, the signal is received by apparatus 300. At step 354, first information based on the received signal is generated. The first information in various embodiments may comprise a vector in the frequency domain calculated by a time-to-frequency conversion of the received signal. At step 356, second information related to crosstalk on the transmission line is generated based on a comparison of the first information with information based on the predetermined information which has been used by apparatus 200 to generate the first signal. According to one embodiment, the vector in the frequency domain calculated based on the received first signal may be compared for each frequency to a predetermined constellation vector in the frequency domain and the second information may be based on the error between these two vectors also known in the art as decision error. According to one embodiment, the real and imaginary part of the error between these two vectors may be quantized such that the second information comprises reduced information, for example only the sign of the real and imaginary part of the decision error for each carrier. At step 358, a signal representing the second information is transmitted back to the apparatus 200 to modify the values related to precompensation based on the second information.

According to one embodiment, the predetermined information may be information pre-known to each of the devices, for example pre-known information described in the transmission standard used by the transmission system. In some embodiments, contrary to systems using signals unknown to the receiver, the decision error introduced at the comparator on the receiving side can be exactly determined for pre-known information thereby eliminating any error in determining the information related to crosstalk which may be introduced when using a first signal based on known information unknown to the second apparatus 300.

In some embodiments, the predetermined information may be pseudo-random information, for example pseudo-random information generated by a feedback shift register. The predetermined information may be fully stored in a memory of apparatus 200 or only reduced information may be stored to generate the predetermined information by inputting the reduced information into a machine such as a processor or a feedback-shift register.

In some embodiments, the first signal represents a signal wherein all carriers provided for transmission from apparatus 200 to apparatus 300 are modulated by predetermined information. Thus, in the first signal, information carried by each of all carriers available for transmission from apparatus 200 to apparatus 300 is based on predetermined information and not user data. In other words, according to these embodiments, the predetermined information is transmitted by the first signal on all carriers available for transmission from apparatus 200 to apparatus 300 and no user data is contained within the first signal.

According to one embodiment, the predetermined information may be a predetermined DMT-symbol. According to one embodiment, the predetermined DMT-symbol may be a predetermined QPSK-symbol or a predetermined BPSK-symbol. QPSK-symbols and BPSK-symbols are low-bit symbols where each carrier is mapped only onto 2 bits (QPSK) or 1 bits (BPSK). According to one embodiment, the predetermined information may be a predetermined universal symbol of the transmission system provided for example according to a standard used by the transmission system for transmission. According to one embodiment, the predetermined information may be a control signal which is transmitted from apparatus 200 to apparatus to control at least one function of apparatus 300 based on the control signal. According to one embodiment, the control signal may be a synchronization signal controlling the starting of processes within apparatus 300 such as for example a VDSL 2 DMT-synchronization symbol. In come embodiments, combinations of one or more of the above described predetermined information may also be provided.

According to one embodiment, the controller may control the modulator such that the first signal is repeatedly generated based on predetermined information and transmitted over transmission line 102. One signal or a plurality of signals representing user data or data useful for a user, for example data requested by the user, may be provided and transmitted between each of the repeatedly transmitted first signals. The predetermined information may be the same for each of the repeatedly generated first signals. In one embodiment, different predetermined information may be used according to a predetermined switching scheme. For example, each of the repeatedly generated first signals may be mapped according to a predetermined scheme to at least one of a plurality of predetermined information.

In some embodiments, apparatus 200 may comprise a demodulator coupled to the terminal 204 to receive a plurality of transmission signals from the transmission line 102 and providing a plurality of information based on the plurality of received transmission signals. A selector may be coupled to the demodulator to identify the information related to crosstalk from the plurality of other information provided by the demodulator. Furthermore, apparatus 200 may comprise a machine to modify crosstalk precompensation information, for example precompensation coefficients, based on the identified information.

According to one embodiment, the modulator 202 may comprise a DMT-symbol generator encoding the first information onto a plurality of DMT-carriers and generating DMT-symbols. According to this embodiment, controller 208 controls the plurality of DMT-symbol generator such that at least one of the DMT-symbols is based on the predetermined information.

According to one embodiment, the modulator 202 generates the transmission signals based on encoding the plurality of information to a plurality of carriers of a transmission line according to a bitloading map. According to this embodiment, the controller 208 controls the modulator to generate the first signal independent of the bitloading map by using only QPSK modulation or BPSK modulation.

In some embodiments, the generation of the first signal which is provided for “testing” the cross coupling on a transmission line by using QPSK modulation provides a modulation wherein all constellation points of the signal have the same energy. This provides an improved convergence for training algorithms training the precompensation information for example during an initialization of apparatus 300.

In some embodiments, modifying and training of the precompensation coefficients may involve linear algorithms, non-linear algorithms or neural networking algorithms. In one embodiment, a singular value decomposition (SVD) technique may be used providing a diagonalization of the carrier matrix (channel matrix). In other embodiments, a Tomlinson-Harashima-basea crosstalk precompensator may be used as known in the art. Furthermore, in one embodiment, neural networks or neural network techniques may be used. In other embodiments, only partial crosstalk compensation may be provided. The partial crosstalk may be carrier selective (frequency selective), such that only selected carriers (tones) may be involved in precompensation based on the influence of these carriers to crosstalk. Furthermore, the partial crosstalk may be line selective, such that for a specific transmission line only selected carriers may be involved in providing precompensation taking into account that crosstalk may vary between different lines. Line selective crosstalk compensation is also known as space selective crosstalk compensation. Carrier-selective and Line-selective compensation may be combined in one embodiment. To implement the carrier- and line-selective compensation, Carrier- and Line-Algorithms may be provided selecting the carriers and Lines to be used in precompensation.

It is to be noted that embodiments of the present invention may be provided for all precompensation techniques based on a feed-back of information related to the crosstalk experienced by a transmitted signal from the receiver to the transmitter. Furthermore, embodiments may incorporate any training technique or adapting technique used for training or adapting precompensation values or precompensation coefficients.

In other words, the embodiments of the present invention may be used independent of a specific precompensation technique used for precompensation and independent of a training technique or an adapting technique used for training or adapting precompensation values.

According to one embodiment, apparatus 200 may comprise a plurality of further modulators coupled to a plurality of further transmission lines. A central controller may be provided controlling the transmission of signals on the transmission lines according to time slots. In specific, transmission of signals on the transmission lines is synchronized such that signals transmitted on one of the transmission lines and signals transmitted on the other of the transmission lines are provided in same time slots by the central controller. The central controller may provide data information related to data transmitted by the other transmitters within the time slot in which the first transmission signal generated based on predetermined information has been transmitted by one of the transmission lines. Crosstalk precompensation information such as crosstalk precompensation coefficients may then be modified based on the data information and the information related to crosstalk received from apparatus 300.

According to one embodiment, one or more carriers of the carriers provided for transmission from apparatus 300 to apparatus 200 may be exclusively or non-exclusively reserved for feeding the information related to crosstalk from apparatus 300 back to apparatus 200. In this embodiment, the demodulator of apparatus 200 may provide for each received signal a plurality of information associated with a respective one of the plurality of carriers of the transmission line, and the selector provided in apparatus 200 selects the information related to crosstalk based on the reserved carriers.

FIG. 4 illustrates a block diagram of one embodiment of the apparatus 300. According to this embodiment, a selector 308 is coupled to the terminal 302 to select information related to the first signal based on a predetermined scheme. The selector 308 is coupled to the machine 304 generating the information related to crosstalk. Furthermore, as described above, the machine 304 is coupled to a modulator 306 generating a transmission signal transmitted via terminal 302 to apparatus 200.

In various embodiments, the predetermined scheme used by selector 308 may provide a selection of every nth incoming signal. Selection may be based on the information contained within the first signal which may provide indication that the received signal is the first signal. Furthermore, the first signal may be contained within a frame or superframe, for example a VDSL 2 superframe, and the predetermined scheme may provide a selection of a specific symbol or range within the frame or superframe for example a specific numbers related to the position of the symbols within the frame or superframe. In one embodiment, the first signal is a DMT-symbol and every nth incoming DMT-symbol is selected by the selector.

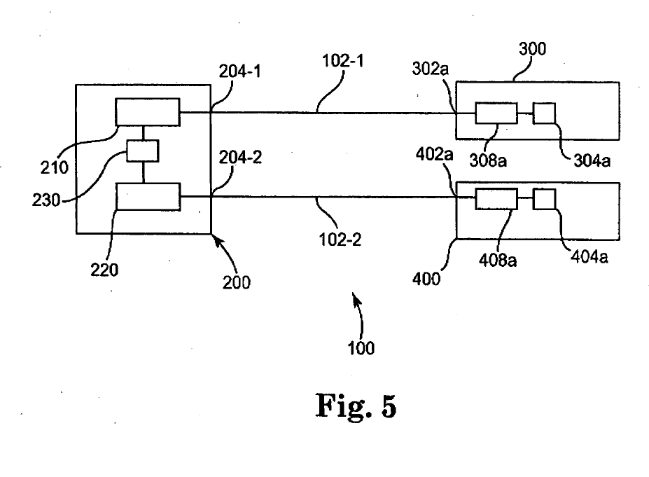

FIG. 5 illustrates one embodiment of the invention. In this embodiment, apparatus 200 comprises a first transceiver 210 and a second transceiver 220. The first transceiver 210 is coupled to a first terminal 204-1 and the second transceiver 22b is coupled to a second terminal 204-2. The first and second terminals 204-1 and 204-2 are coupled to first and second transmission lines 102-1 and 102-2., respectively. The first and second transceivers are coupled to the controller 230 controlling transmission of signals by the first and second transceivers 210 and 220. Each of the apparatuses 300 and 400 comprises a terminal, 302a and 402a respectively and a selector 308a and 408a coupled to the terminal 302a and 402a, respectively. The selectors 308a and 408a are coupled to machines 304a and 404a, respectively.

In the illustrated embodiment, the first and second transceivers each transmit a plurality of signals over transmission lines 102-1 and 102-2, respectively. The controller 230 controls the transceivers 210 and 220 such that the first transceiver 210 transmits a specific first signal of the plurality of transmitted signals and the second transceiver 220 transmits a specific second signal of the plurality of transmitted signals transmitted by the second transceiver 220 time-shifted to each other. The first and second signals are received by apparatuses 300 and 400 and are identified by the respective selectors 308a and 408a using a predetermined scheme. According to one embodiment, the first and second signals are transmitted in a non-overlapping scheme. For example, the first signal may be transmitted within a first time-slot and the second signal may be transmitted within a second timeslot different than the first timeslot. Each of the apparatuses 300 and 400 may comprise a modulator or transmitter transmitting signals representing the information related to crosstalk back to the first apparatus 200. The first apparatus may comprise a precompensator providing precompensation to signals transmitted by the first and second transceivers 210 and 220 based on precompensation information and a machine modifying the precompensation information based on the signals transmitted back from each of the apparatuses.

It is to be noted that in various embodiments, the first and second information may be predetermined information as described above with respect to FIGS. 2 to 4. In other words, the embodiments with respect to FIGS. 2 to 4 and the embodiment according to FIG. 5 may be combined.

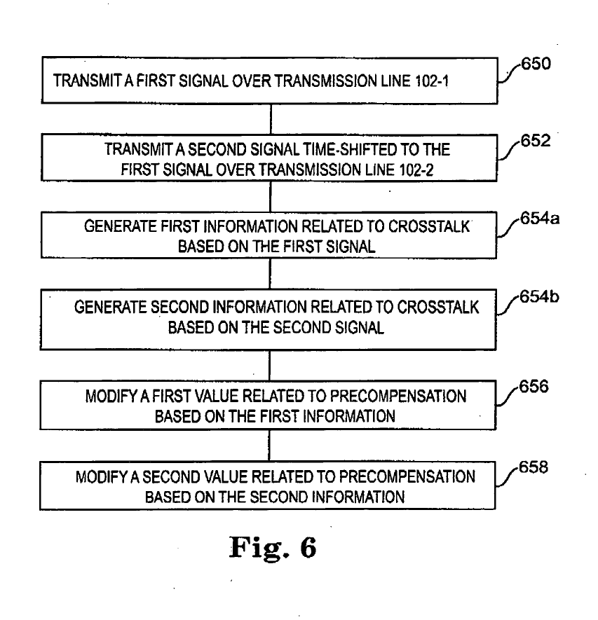

FIG. 6 illustrates a flow diagram of one embodiment of the operation of a system illustrated in FIG. 5. At step 650, a first signal is transmitted on the transmission line 102-1 from an apparatus 200 to apparatus 300. At step 652, a second signal is transmitted time-shifted with respect to the first signal on the transmission line 102-2 from the apparatus 200 to the apparatus 400. At step 654a, first information related to cross-talk on the transmission line 102-1 based on the first signal is generated. In a step 654b, second information related to cross-talk on the transmission line 102-2 based on the second signal are generated. At step 656, a first value related to precompensation of cross-talk based on the first information is modified by apparatus 200. At step 658, a second value related to precompensation of cross-talk based on the second information is modified by apparatus 200.

According to one embodiment, the transmission may be a DMT-based system using DMT-modulation. The controller 230 may comprise a scheduler having a control circuit to time-shift the transmission of synchronization DMT-symbols, for example VDSL 2 synchronization DMT-symbols. In various embodiments, the scheduler may control transmission of the superframes such that a superframe transmitted over transmission line 102-1 is time-shifted with respect to a second superframe transmitted over transmission line 102-2. Since the synchronization DMT-symbols are provided always at the same position within the superframe, the time-shifted transmission of superframes results in a time-shift of the synchronization symbol.

It is to be noted that the embodiments described with respect to FIG. 4 may also comprise more than two transmission lines. For a transmission system comprising n transmission lines, each apparatus 200 may comprise n transceivers, each of the n transceivers associated with one of the transmission lines. The transceivers may be controlled by controller 230 to transmit the signals used by the respective receiving devices for generating the information related to crosstalk time-shifted to each of the other signals used by the other receiving devices for generating the information related to crosstalk.

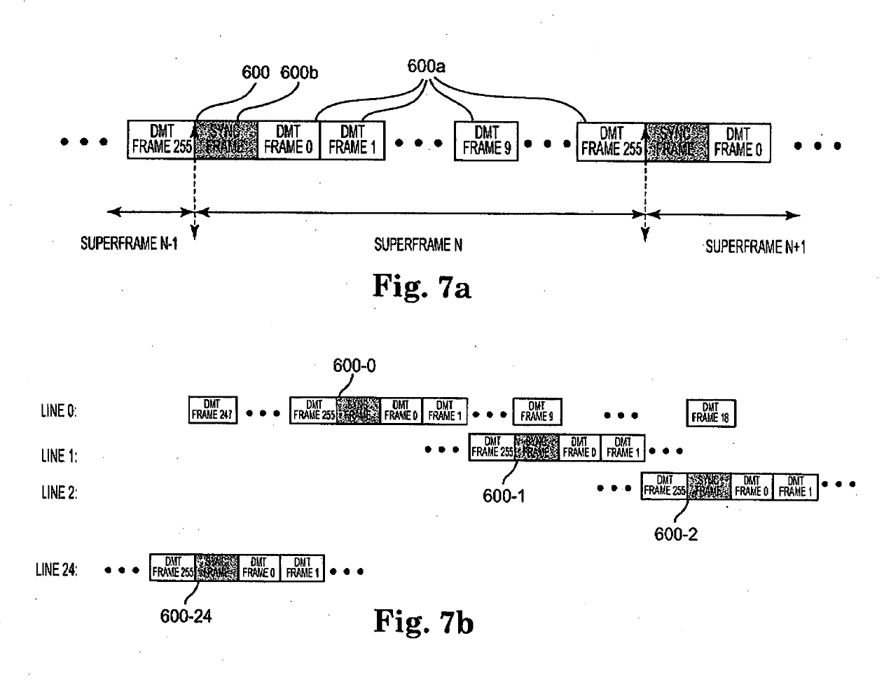

FIGS. 7a and 7b are diagrams that illustrate embodiments of the invention. According to one embodiment, superframes such as for example superframes as used by the VDSL 2 standard may be used for transmitting the signals over a plurality of transmission lines. FIG. 7a shows an exemplary embodiment of a VDSL 2 superframe comprising a plurality of DMT-symbols (DMT-frames) 600. According to FIG. 7a, 256 DMT-symbols 600a comprising user data (useful data) and one predetermined (pre-known) synchronization symbol 600b are aggregated to one superframe.

FIG. 7b illustrates an embodiment of scheduling of a plurality of superframes 600-0 to 600-24 for a plurality of 25 transmission lines. As can be seen in FIG. 7b, transmission of a superframe 600-0 on transmission line 0 is time-shifted with respect to the transmission of superframe 600-1 transmitted on line 1 compared to the superframe 600-0 by a time interval corresponding to 9 DMT-symbols. Furthermore, the transmission of a superframe 600-2 is time-shifted by a time interval corresponding to 9 DMT-symbols etc. Thus each superframe is time-shifted by a predetermined time-interval. Although FIG. 7b shows a time-interval corresponding to 9 DMT symbols, it is to be understood that other embodiments may encompass other time-intervals. Furthermore, the time-interval between superframes corresponding to consecutive transmission lines may be constant or may be non-constant.

According to above embodiment, the information related to crosstalk is only detected during the synchronization symbol providing a reduction of information related to crosstalk transmitted back to apparatus 200. Furthermore, since the synchronization symbol is a pre-known symbol, errors in the decision are eliminated resulting in an exact measurement of the information related to crosstalk.

The distribution of the synchronization symbols provides a more relaxed handling of the precompensation information. According to one embodiment, a precompensation algorithm of a precompensator provided by apparatus 200 may modify or adapt the precompensation information related to the different transmission lines one after another, thereby removing any workload peaks and distributing the workload over time.

It is to be noted that the above embodiments or parts of the described embodiments may be implemented by hardware, software, firmware or combinations thereof.

According to one embodiment, a computer program is provided which may be executed on a computing system and controls a first-VDSL-transceiver and a second VDSL-transceiver to transmit first synchronization DMT-symbols transmitted by the first VDSL-transceiver time-shifted to second synchronization DMT-symbols transmitted by the second VDSL-transceiver.

The computer program may control the transceivers described in FIG. 5 such that each of the first synchronization DMT-symbols and each of the second synchronization DMT-symbols are non-overlapping in time. The computer program may control transmission of VDSL 2 superframes as described above, such that each of the superframes transmitted on one transmission line is time-shifted relative to each of the superframes transmitted on the other transmission lines.

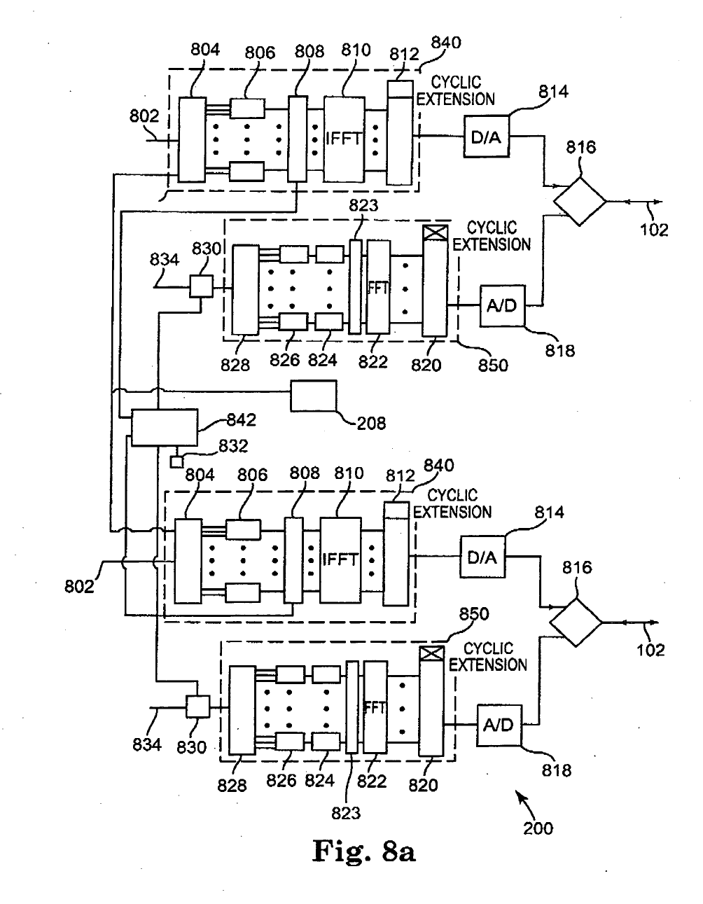

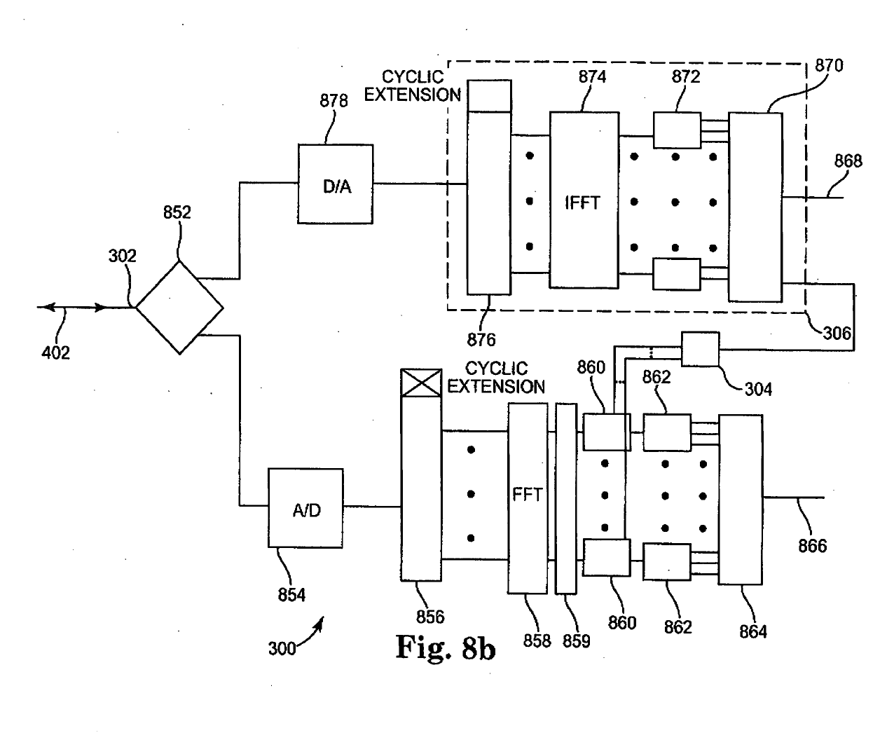

FIGS. 8a and 8b are block diagrams illustrating embodiments of the invention. FIG. 8a illustrates an apparatus 200 comprising of two transceivers with a modulator 840 and a demodulator 850. Each of the transceivers comprises in a transmitting path a data input 802, a first serial-parallel converter 804 and a plurality of symbol generators 806 coupled to the outputs of the serial-parallel converter 804. An input of a precompensator 808 is coupled to the output of the plurality of symbol generators 806 and an output of the precompensator is coupled to the input of a IFFT frequency-time converter 810. The output of the IFFT frequency-to-time converter is coupled to the input of a first parallel-to-serial converter 812. The parallel-to-serial converter adds a cyclic extension to the output signals of the IFFT frequency-time converter 810 and converts the signals into a serial data stream comprised of DMT-data symbols. The DMT-data symbols are provided to the input of a digital-to-analog converter (D/A converter) 814. The output of the D/A converter is connected to a first terminal of a hybrid circuit 816. The hybrid circuit 816 of each transceiver is connected to a respective transmission line 102 for transmitting the analog signal to apparatus 300 and apparatus 400, respectively.

In the illustrated embodiment, the hybrid circuit 816 receives an analog transmission signal from transmission line 102 and provides a digital representative of the received transmission signal via an analog-to-digital converter 818 to the demodulator 850. In specific, the output of the analog-to-digital converter 818 is coupled to an input of a second serial-to-parallel converter 820. The second serial-to-parallel converter 820 receives the digital signal and removes the cyclic prefix added to the signal. The outputs of the serial-to-parallel converter 820 are coupled to a plurality of inputs of a FFT time-to-frequency converter 822. The outputs of the FFT time-to-frequency converter 822 are coupled to frequency domain equalizers 823 which compensate the gain and the phase for each carrier. The output of the frequency domain equalizers are connected to comparators 824 for comparing each output signal representing a complex vector in frequency space with an expected vector in frequency space. The output of each of the comparator is connected to respective bit mappers 826 mapping the constellation vector to bit values. An input of a second parallel-to-serial converter 828 mapping the plurality of bit values received in parallel at the inputs to a single data stream at the output of the parallel-to-serial converter 828 according to a bit loading scheme.

In the illustrated embodiment, the output of the parallel-to-serial converter 828 is connected to a selector 830 separating the data related to crosstalk from other data. It is to be noted that various modification of the connection of selector 830 are possible. For example, the selector may be integrated within the parallel-to-serial converter 828 or the converter may be directly coupled to respective outputs of the bit mappers 826. The selector 830 is coupled at a first output to a data output providing the data transmitted on carriers other than the reserved carriers to a data output 834. The selector 830 is further coupled at a second output to a machine 842. The machine 842 modifies values of the precompensation information used by precompensator 808 for example as described with respect to FIG. 1c based on the received information related to crosstalk. The machine 842 may be a processor executed by software or firmware with computer algorithms for training the precompensation information or modifying the precompensation information during normal operation. The machine 842 may be coupled to a memory 832 for storing the actual precompensation values used by the precompensator 808.

In the illustrated embodiment, memory 832 may also store information related to the indices of the carriers which is provided to the selector 830 for determining which data corresponding to the reserved carriers may be separated. Memory may, according to an embodiment, also be coupled to the data input 802 of each of transceivers to store the data transmitted by the transceivers. The controller 208 described with respect to the embodiments according to FIGS. 2 to 7 is coupled to each serial-parallel converter 804 for controlling the scheduling of the signals transmitted by each transceiver to the respective receivers. However, it is to be noted that various modification of the arrangement and coupling of the controller 208 are possible. The controller 208 may be directly coupled to the symbol generators. Furthermore, the controller 208 may be coupled to other parts of the modulator or to separate units such as a separate time scheduler for each transceiver coupled to the modulator 840. It is to be noted that the controller 208 may also incorporate all functions described with respect to the controller 230 shown in the embodiment according to FIG. 5

FIG. 8b illustrates a further embodiment of the apparatus 300. As described above, input terminal 302 of apparatus 300 is provided for connection to the transmission line 102. A hybrid circuit 852 is connected to the terminal 302 for separating receiving and transmitting signals. A receiving signal is passed to an analog-to-digital converter 854 connected to a first serial-to-parallel converter 856. The serial-to-parallel converter 856 removes the cyclic extension and passes the received bits to a FFT time-to-frequency converter 858. Outputs of the FFT time-to-frequency converter 858 are coupled to a plurality of frequency domain equalizers 859. The output of the frequency domain equalizers are connected to a plurality of comparators 860 comparing the received data representing complex vectors in a frequency space to expected vectors. The plurality of comparators 860 are coupled to a plurality of bit mappers 862 mapping the vectors output by the FFT to respective bits. The plurality of bit mappers 862 are coupled to a parallel-to-serial converter 864 converting the parallel received bits to a serial data stream provided at a data output 866.

In embodiments of the transmission path of apparatus 300, a data input 868 of the modulator 306 is coupled to a second serial-to-parallel converter 870. The second serial-to-parallel converter 870 is coupled to a plurality of symbol generators 872 having outputs coupled to inputs of an IFFT-frequency-to-time converter 874. The outputs of the IFFT-frequency-to-time converter 874 are coupled to inputs of a second parallel-to-serial converter 876 adding a cyclic extension to the received parallel data and converting same to a serial data stream provided to an input of a D/A converter 878. The D/A converter 878 is coupled to the hybrid circuit 852 for transmitting the analog signal over transmission line 102.

In the embodiment shown in FIG. 8b, the machine 304 generating information related to crosstalk is coupled to each of the comparators 860. The machine 304 receives, for example, from the comparators 860 information related to a decision such as the real and imaginary part of an error between the received constellation vector and an expected constellation vector in the frequency domain for each carrier. The machine 304 may reduce the received information to generate the information related to crosstalk by determining, for example, the sign of the decision error for the real and imaginary part of each carrier. The information related to crosstalk is then provided to serial-to-parallel converter 870 for modulation onto carriers provided for transmission in the direction from apparatus 300 to apparatus 200. It is to be noted that according to one embodiment, the information related to crosstalk is modulated onto at least one carrier reserved exclusively or non-exclusively for the transmission of information related to crosstalk information. The carriers or the number of carriers reserved for transmission of crosstalk information may according to one embodiment be dynamically switched during operation of apparatus 300.

While embodiments have been described with respect to apparatus 200 to have a plurality of transmitters or transceivers within one unit, it is to be noted that some or all of the plurality of transmitters may be located on a single chip or on different chips or within different housings which are coupled to transfer the information related to the data send over the plurality of transmission lines.

Furthermore, the functional units described with respect to the apparatus 300 or 400 may be provided on a single chip or on different chips.

Although the invention has been illustrated and described with respect to one or more implementations, alterations and/or modifications may be made to the illustrated examples without departing from the spirit and scope of the appended claims. In particular regard to the various functions performed by the above described components or structures (blocks, units, assemblies, devices, circuits, systems, etc.), the terms (including a reference to a “means”) used to describe such components are intended to correspond, unless otherwise indicated, to any component or structure which performs the specified function of the described component (e.g., that is functionally equivalent), even though not structurally equivalent to the disclosed structure which performs the function in the herein illustrated exemplary implementations of the invention. In addition, any direct connection or coupling between two points, functional blocks, devices or other physical or functional units shown or described herein can be implemented by indirect connection or coupling including further elements or functional blocks in between. For example, one or more equalizers in time or frequency domain, interleavers, de-interleavers, scramblers, de-scramblers, filters, interfaces or drivers may be provided depending on requirements of specific embodiments. Furthermore, while a particular feature of the invention may have been disclosed with respect to only one of several implementations, such feature may be combined with one or more other features of the other implementations as may be desired and advantageous for any given or particular application. Furthermore, to the extent that the terms “including”, “includes”, “having”, “has”, “with”, or variants thereof are used in either the detailed description and the claims, such terms are intended to be inclusive in a manner similar to the term “comprising”.

What is claimed is:

1. A device comprising:
a terminal to receive a first transmission signal;
a machine generating information related to crosstalk by comparing first information based on the received first transmission signal with second information based on predetermined information; and
a transmitter coupled to the terminal to transmit a second signal representing the second information.

2. The device according to claim 1, further comprising
a memory to store the predetermined information.

3. The device according to claim 1, the device comprising a second machine generating the first information based on predetermined input information.

4. The device according to claim 3, wherein the second machine is a feedback shift-register.

5. The device according to claim 1, wherein the second information is a predetermined DMT-symbol.

6. The device according to claim 5, wherein the predetermined DMT-symbol is a predetermined QPSK-symbol or a predetermined BPSK-symbol.

7. The device according to claim 1, wherein the first transmission signal is a control signal and wherein the device further comprises a controller receiving the control signal and controlling at least one function of the device based on the control signal.

8. The device according to claim 6, wherein the predetermined DMT-symbol is a VDSL 2 synchronization symbol.

9. A system comprising:
a first device;
a second device;
a first transmission line coupling the first and second device;
the first device comprising:
a modulator to receive first information and to generate a plurality of transmission signals based on modulating the first information onto a plurality of carriers of the first transmission line;
a first terminal to transmit the plurality of transmission signals over the first transmission line;
a controller controlling the modulator to generate a first transmission signal of the plurality of transmission signals based on predetermined information;
the second device comprising:
a second terminal to receive the first transmission signal;
a machine generating third information related to a crosstalk on the transmission line during the transmission of the first signal based on a comparing of second information related to the received first transmission signal with information based on the predetermined information; and
a transmitter coupled to the terminal to transmit a second transmission signal representing the third information from the second device to the first device.

10. The system according to claim 9, wherein the first device further comprises:
a demodulator to receive a plurality of transmission signals from the first transmission line and to provide a plurality of information based on the plurality of received transmission signals;
a selector to identify information related to the second signal from the plurality of information;
a machine to modify crosstalk precompensation information based on the identified information.

11. The system according to claim 9, wherein the modulator comprises:
a DMT-symbol generator encoding the first information onto a plurality of DMT-carriers and generating a plurality of DMT-symbols; and
wherein the controller controls the DMT-symbol generator to generate at least one of the DMT-symbols based on the predetermined information.

12. The system according to claim 10, the first device further comprising:
at least one further first modulator coupled to a second transmission line; and
a controller providing fourth information related to data transmitted by the further transmitter during the time slot of the first transmission signal; and
wherein the machine modifies the crosstalk precompensation information of signals based on the third information and the fourth information.

13. The system according to claim 11, wherein the demodulator provides a plurality of information for each received signal, each information of the plurality of information being associated with one of a plurality of carriers of the transmission line, and wherein the selector selects the second information by selecting information associated with predetermined carriers, the predetermined carriers being reserved for transmission of information related to crosstalk.

14. The system according to claim 9, wherein the controller controls the modulator to repeatedly provide the first transmission signal such that a plurality of signals representing other data is transmitted between each of the first transmission signals.

15. A method comprising:
receiving a first signal transmitted over an transmission line, the first signal being generated based on predetermined information;
generating at least one first information based on the received first signal;
generating second information related to crosstalk on the transmission line based on a comparing of the at least one first information with information based on the predetermined information;
transmitting a second signal representing the second information related to crosstalk.

16. The method according to claim 15, further comprising:
modifying crosstalk precompensation information based on the information related to crosstalk.

17. The method according to claim 16, wherein generating at least one first information, generating second information and transmitting the signal representing the second information are permanently repeated and wherein a plurality of signals representing usefull data are transmitted between each of the transmitted signals.

18. The method according to claim 15, wherein generating at least one first information comprises generating a DMT-symbol based on the received signal and wherein generating second information comprises generating the second information by comparing the DMT-symbol with a predetermined DMT-symbol.

19. The method according to claim 18, wherein the predetermined symbol is a QPSK-modulated or a BPSK-modulated symbol.

20. The method according to claim 19, wherein the predetermined symbol is a universal symbol of a xDSL transmission protocol.

21. The method according to claim 15, wherein the predetermined DMT-symbol is a synchronisation symbol.

22. The method according to claim 15, wherein the first signal is a VDSL 2 signal.

23. The method according to claim 15, further comprising:
transmitting the first signal from a first device to a second device;
transmitting the second signal representing the second information from the second device to the first device by using only at least one predetermined carrier of a plurality of carriers, the predetermined carrier being reserved for transmission of the second information.

24. A method comprising receiving a plurality of signals transmitted over a transmission line;
selecting a first signal from the plurality of signals by using a predetermined scheme; and
providing information related to crosstalk during the transmission of the first signal based on the selected signal.

25. The method according to claim 24, wherein the plurality of signals are DMT-symbols and wherein selecting a first signal comprises selecting every nth DMT-symbol.

26. The method according to claim 25, wherein the first signal is a synchronisation signal.

27. The method according to claim 25, wherein the DMT-symbols are provided by QPSK-modulation or BPSK-modulation.

28. A device comprising:
a terminal to receive a plurality of signals transmitted over a transmission line;
a selector selecting a first signal from the plurality of signals based on a predetermined scheme; and
a machine providing information related to crosstalk during the transmission of the first signal based on the selected first signal.

29. The device according to claim 28 further comprising a DMT-decoder providing a plurality of DMT-symbols based on the received plurality of signals and wherein the selector selects every nth DMT-symbol from the plurality of DMT-symbols.

30. A system comprising:
a first device;
a second device;
a third device;
a first transmission line coupling the first and second device;
a second transmission line coupling the first and third device;
the first device comprising:
a first transceiver to transmit a first plurality of signals on a first transmission line and to receive a second plurality of signals from the first transmission line;
a second transceiver to transmit a third plurality of signals on a second transmission line and to receive a fourth plurality of signals from the second transmission line;
a controller controlling the first transceiver to generate a first signal of the first plurality of signals based on first information and controlling the second transceiver to generate, time shifted with respect to the first signal, a second signal of the second plurality of signals based on second information;
the second device comprising:
a terminal to receive the first plurality of signals transmitted over the first transmission line;
a selector identifying the first signal from the first plurality of received signals by using a predetermined scheme; and
a machine providing third information related to crosstalk during the transmission of the first signal based on the identified signal;
the third device comprising:
a terminal to receive the third plurality of signals transmitted over the second transmission line;
a selector identifying the second signal from the third plurality of received signals by using a predetermined scheme; and
a machine providing third information related to crosstalk during the transmission of the second signal based on the identified signal.

31. The system according to claim 30, wherein
the second device comprises a second transmitter to transmit a fourth signal representing the third information;
the third device comprises a third transmitter to transmit a fifth signal representing the fourth information;
the first device further comprises:
a first terminal to receive the fourth signal;
a second terminal to receive the fifth signal;
a precompensator providing precompensation of crosstalk from the second transmission line to the first transmission line for the first plurality of signals based on first precompensation information and providing precompensation of crosstalk from the first transmission line to the second transmission line for the second plurality of signals based on second precompensation information;
a machine modifying the first and second precompensation information based on the fourth and fifth signal.

32. A scheduler controlling transmission of first synchronisation DMT-symbols transmitted by a first VDSL-transceiver and controlling transmission of second synchronisation DMT-symbols transmitted by a second VDSL-transceiver, the scheduler comprising a control circuit to time-shift transmission of the second synchronisation DMT-symbols relative to the transmission of the first synchronization DMT-symbols by a predetermined time interval.

33. The scheduler according to claim 32, wherein the control circuit time-shifts transmission of the second synchronisation DMT-symbols such that each of the first synchronisation DMT-symbols and each of the second synchronisation DMT-symbols are non-overlapping in time.

34. The scheduler according to claim 32, the scheduler controlling transmission of first superframes wherein each of the first superframes comprises a plurality of first DMT-symbols and a first synchronisation DMT-symbol, and controlling transmission of second superframes wherein each of the second superframes comprises a plurality of second DMT-symbols and a second synchronisation DMT-symbol, and wherein the control circuit delays transmission of the first superframe relative to the transmission of the second superframe by a predetermined time interval.

35. A computer program, when executed on a computing system, controlling a first VDSL-transceiver and a second VDSL-transceiver to transmit first synchronisation DMT-symbols transmitted by the first VDSL-transceiver time-shifted to second synchronisation DMT-symbols transmitted by the second VDSL-transceiver.

36. The computer program according to claim 35, wherein the first and second VDSL-transceivers are controlled such that each of the first synchronisation DMT-symbols and each of the second synchronisation DMT-symbols are non-overlapping in time.

37. The computer program according to claim 35, the computer program controlling transmission of first superframes wherein each of the first superframes comprises a plurality of first DMT-symbols and a first synchronisation DMT-symbol, and controlling transmission of second superframes wherein each of the second superframes comprises a plurality of second DMT-symbols and a second synchronisation DMT-symbol, such that transmission of the first superframe is time-shifted relative to the transmission of the second superframe by a predetermined time interval.

38. A method comprising:
transmitting a first signal on a first transmission line from a first device to a second device and
transmitting time-shifted with respect to the first signal a second signal on a second transmission line from the first device to a third device;
generating first information related to cross-talk on the first transmission line based on the first signal, and generating second information related to cross-talk on the second transmission line based on the second signal;
modifying a first value related to precompensation of cross-talk based on the first information; and
modifying a second value related to precompensation of cross-talk based on the second information.

39. The method according to claim 38, wherein the first signal is repeatedly transmitted and wherein the second signal is repeatedly transmitted such that each transmitted second signal is time-shifted with respect to each transmitted first signal.

40. The method according to claim 39, wherein between each repeatedly transmitted first signal a plurality of signals representing user data is transmitted.

41. The method according to claim 38, further comprising:
transmitting the first information from the second device to the first device;
transmitting the second information from the third device to the first device.

42. The method according to claim 38, wherein the first signal represents a first DMT-symbol and the second signal represents a second DMT-symbol.

43. The method according to claim 38, wherein the first and second DMT-Symbols are identical.

44. The method according to claim 38, wherein the first and second DMT-symbols are synchronisation DMT-symbols of a VDSL 2 superframe.

45. The method according to claim 38, wherein transmitting of the first signal has ended before transmitting of the second signal starts.

46. The method according to claim 38, wherein the start of transmitting the second DMT-symbol is time-shifted with respect to the start of transmitting the first DMT-symbol by a time interval corresponding to at least one DMT-symbol.

47. A xDSL-transmission system comprising:
a first device;
a second device;
a transmission line coupling the first and second device;
the first device comprising
a modulator to receive a plurality of information and to generate a plurality of signals based on encoding the plurality of information to a plurality of carriers of a transmission line according to a bitloading map;
a controller controlling the modulator to generate a first signal independent of the bitloading map by using only QPSK modulation or BPSK modulation;
the second device comprising:
a terminal to receive the plurality of signals transmitted over the transmission line;
a selector to identify the first signal from the plurality of received signals;
a machine to generate, based on the first signal, information related to crosstalk on the transmission line during the transmission of the first signal;
a transmitter to transmit the information related to crosstalk over the transmission line to the first device.

48. The xDSL-system according to claim 47 wherein
the first device comprises:
a precompensation machine to provide precompensation for the plurality of transmission signals based on precompensation information;
a terminal to receive the information related to crosstalk transmitted from the second device to the first device;
a training machine modifying the precompensation information based on the information related to crosstalk.

49. The xDSL-system according to claim 48, wherein the controller controls the modulator to permanently repeat generating the first signal.

50. The xDSL-system according to claim 49, wherein the controller controls the modulator to generate a plurality of transmission signals representing user data between each first signal.

51. The xDSL-system according to claim 50, wherein the first signal comprises a synchronisation DMT-symbol.

52. A method comprising:
generating a first signal by coding data using QPSK modulation or BPSK modulation.
transmitting the first signal over a transmission line from a first device to a second device;
generating information related to crosstalk on the transmission line based on the first signal; and
modifying a value related to precompensation of crosstalk based on the information.

53. The method according to claim 53, wherein generating the first signal and transmitting the first signal is permanently repeated and wherein between each of the repeated first signals at least one signal representing user data is transmitted over the transmission line.

54. The method according to claim 53, wherein the first signal is a DMT-symbol with QPSK modulation.

55. The method according to claim 53, further comprising
transmitting a second signal based on the information related to crosstalk on a reserved carrier, the reserved carrier being reserved for only transmitting information related to crosstalk.
